(19) United States
(12) Patent Application Publication
(10) Pub. No.: US 2025/0222949 A1
(43) Pub. Date: Jul. 10, 2025

(54) AUTONOMOUS VEHICLE CLOUD SERVICES TESTING UTILIZING SIMULATION DATA OF A SIMULATED AUTONOMOUS VEHICLE

(71) Applicant: GM Cruise Holdings LLC, San Francisco, CA (US)

(72) Inventors: Jian Lin, Bellevue, WA (US); Ahmed Abdalla, North Attleborough, MA (US); Siyin Yang, Mercer Island, WA (US)

(21) Appl. No.: 18/404,460

(22) Filed: Jan. 4, 2024

(51) Int. Cl. B60W 60/00

(52) U.S. Cl. CPC B60W 60/001; B60W 2756/10

(57) ABSTRACT

Systems, methods, and non-transitory computer readable mediums are provided for testing and measuring the behavior or logic of one or more cloud services associated with a simulated autonomous vehicle (AV). For example, a system may be configured to receive log data of a simulated AV. In some examples, the log data may characterize one or more events that occurred during a simulation of the simulated AV. Additionally, the system may instantiate an AV bot based on the log data. Moreover, the system may generate, by the instantiated AV bot, a first set of messages. In some examples, the first set of messages may be based on the log data. Further, the system may provide the first set of messages to a cloud service.

### BACKGROUND

### 1. Technical Field

The present disclosure generally relates to cloud services associated with autonomous vehicles (AVs) and, more specifically, testing and measuring the behavior of the cloud services of the AVs.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Additionally, data generated by the sensors may be transmitted to one or more cloud services. The cloud services may manage the autonomous vehicle and provide additional AV-related services to the autonomous vehicle (e.g., remote/roadside assistance services).

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 illustrates an example simulation framework, according to some examples of the present disclosure;

FIG. 3 illustrates portions of an example system environment, in accordance with some exemplary embodiments;

FIG. 4 illustrates a flowchart of an example process for generating an AV bots script based on log data of a simulation;

FIG. 5 illustrates an example of a deep learning neural network, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

In some examples, a computing environment may include a first computing system that may implement operations that simulate an autonomous vehicle (AV) in an environment and test and measure the behavior of the simulated AV. Additionally, the computing environment may include a separate second system that may test and measure behaviors of cloud services of one or more AVs based on messages generated by an AV bot. Moreover, the AV bot may be representative of the one or more AVs and may be based on one or more inputs provided by an operator of the computing system. The one or more inputs may be based on the operator's understanding of the behavior of AVs in a hypothetical environment. However, the operator's understanding may not necessarily be an accurate depiction of an AVs behavior in the environment. As such, the tested and measured behaviors of the cloud services that are based on messages generated by the AV bot may not accurately reflect the actual behaviors of the cloud services. Messages generated by the simulated AV may be a better representative of the behavior of an actual AV compared to the AV bot. To complicate matters, the first computing system may not have a way to interface with the second computing system.

Aspects of the disclosed technology provide solutions for interfacing an output of an AV simulation to one or more cloud services so that the behaviors of the cloud services may be more accurately tested and measured. As described herein, a computing environment that includes the first computing system and the second computing system may include an additional layer that enables an output of an AV simulation to be communicated to one or more cloud services. In some examples the additional layer may include one or more AV bots and the instantiation of the one or more AV bots may be based on the output (e.g., log data) of the AV simulation.

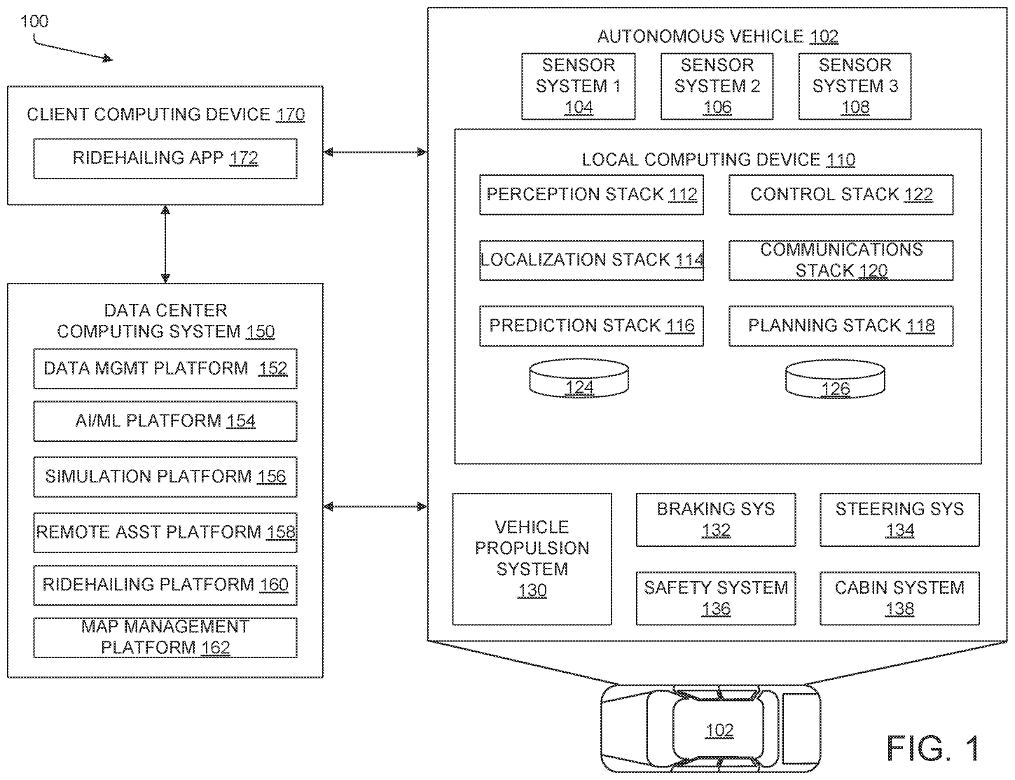

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes autonomous vehicle (AV) 102, a data center computing system 150, and a client computing device 170. AV 102, the data center computing system 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center computing system 150, and the client computing device 170, among other systems. The local computing device 110 can include one or more processors and memory, including instructions that can be executed by the one or more processors. The instructions can make up one or more software stacks or components responsible for controlling the AV 102; communicating with the data center computing system 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center computing system 150, the client computing device 170, third party data sources, etc.). The perception stack 112 can detect and classify objects and determine their current locations, speeds, directions, and the like. Additionally, perception stack 112 may generate perception data based on the sensor data (e.g., sensor data generated from cameras, LIDAR sensors, infrared sensors, microphones, ultrasonic sensors, RADAR, pressure sensors, force sensors, impact sensors, etc.). In some examples, the perception data may be based on localization data generated by localization stack 114. As described herein, the perception data may identify and classify objects, such as road agents, around AV 102. Additionally, the perception data may include information characterizing, for each identified object, a corresponding current location, speed, direction, and the like. Moreover, the perception information may include information characterizing, for each identified object, the free space around the AV 102.

In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. Additionally, perception stack 112 may generate perception data that identifies the identified environmental uncertainties. In some examples, an output of the perception stack 112, such as the perception data, can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Additionally, localization stack 114 may generate localization data based on the sensor data (e.g., sensor data generated from GPS, IMUs, cameras, LIDAR, RADAR, ultrasonic sensors, etc.). As described herein, the localization data may indicate the location and/or pose of AV 102. Additionally, the location of AV 102 may be the current location of AV 102, while the pose of AV 102 may be the position and orientation of AV 102. In some examples, the localization data may be further based on HD map data stored in HD geospatial database 126. For example, in some cases, localization stack 114 may compare sensor data captured in real-time by one or more sensor systems, such as sensor systems 104, 106 and 108 to HD map data stored in HD geospatial database 126 to determine its precise (e.g., accurate to the order of a few centimeters or less) position and orientation.

Prediction stack 116 can receive information from the localization stack 114, such as localization data, and objects identified in perception data generated by the perception stack 112 and predict a future path for the objects. Additionally, prediction stack 116 may generate prediction data that identifies and characterizes the future path for the objects. In some examples, the prediction stack 116 may determine and generate prediction data that identifies and characterizes, for each object identified in the perception data, several likely paths that an object is predicted to take along with a probability associated with each path. For each predicted path, the prediction stack 116 may determine and generate prediction data that identifies and characterizes a range of points along the path corresponding to a predicted location of the object along the path at future time intervals along with an expected error value for each of the points that indicates a probabilistic deviation from that point.

Planning stack 118 may generate planning data based on prediction data and perception data. Additionally, planning stack can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. The planning data may include the selected set of one or more mechanical operations that AV 102 can perform. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center computing system 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center computing system 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store map data of HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center computing system 150, the client computing device 170, etc.). In some examples, the raw AV data can include HD LIDAR point cloud data, image data, RADAR data, GPS data, and other sensor data that the data center computing system 150 can use for creating or updating AV geospatial data or for creating simulations of situations encountered by AV 102 for future testing or training of various machine learning algorithms that are incorporated in the local computing device 110.

Data center computing system 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center computing system 150 can include one or more computing devices remote to the local computing device 110 for managing a fleet of AVs and AV-related services. For example, in addition to managing the AV 102, the data center computing system 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center computing system 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, data center computing system 150 includes i a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center computing system 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center computing system 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs, such as AV 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center computing system 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the client application 172 to enable passengers to view the AV 102 in transit en route to a pick-up or drop-off location, and so on.

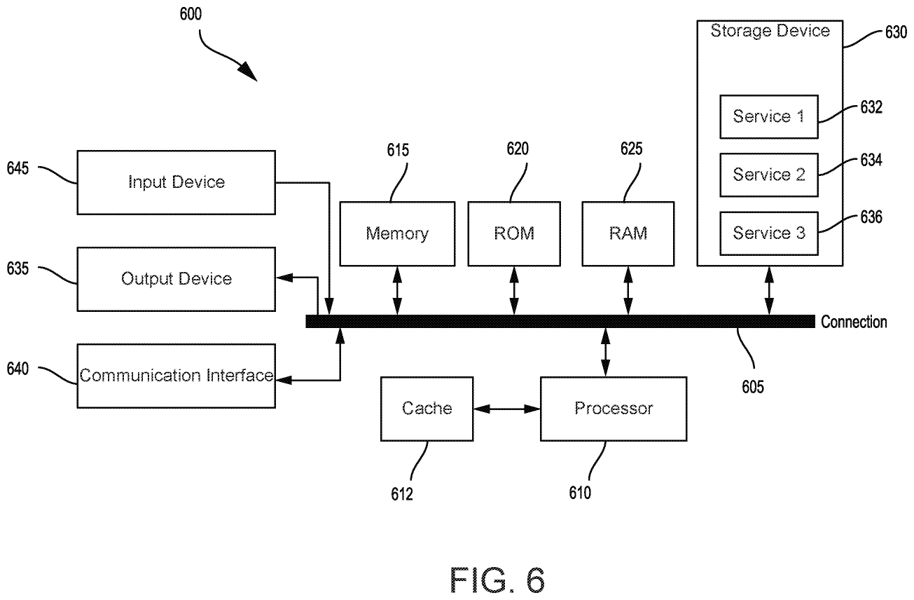

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

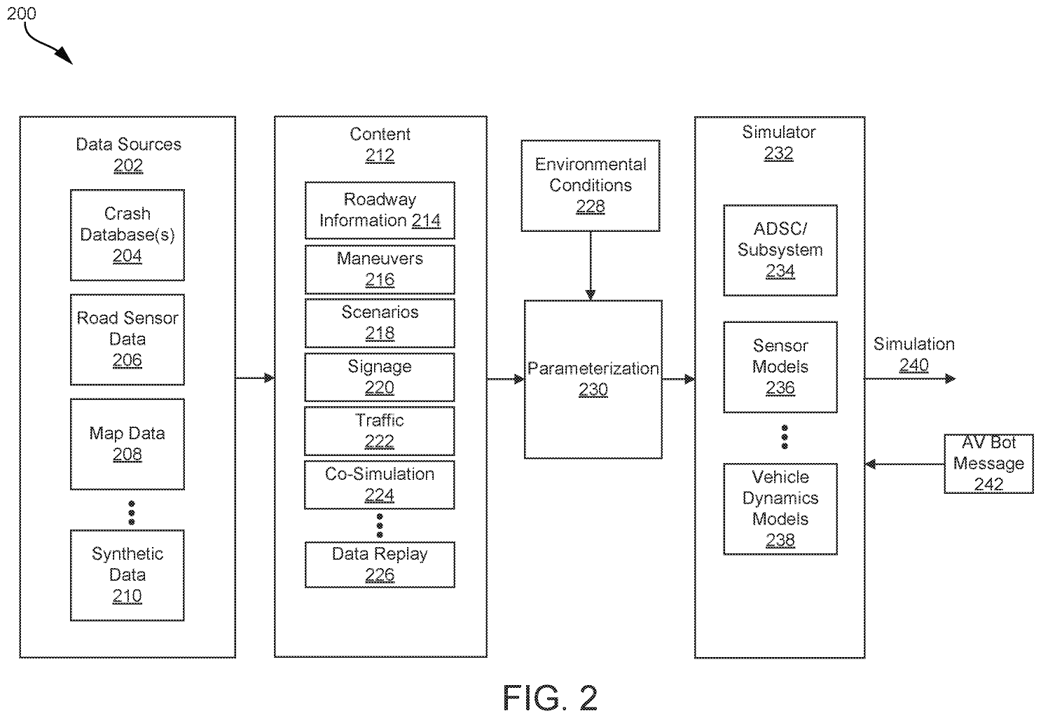

FIG. 2 is a diagram illustrating an example simulation framework 200, according to some examples of the present disclosure. The example simulation framework 200 can include data sources 202, content 212, environmental conditions 228, parameterization 230, and simulator 232. The components in the example simulation framework 200 are merely illustrative examples provided for explanation purposes. In other examples, simulation framework 200 can include other components not shown in FIG. 2 and/or more or less components than shown in FIG. 2.

Data sources 202 can be used to create a simulation. The data sources 202 can include, for example and without limitation, one or more crash databases 204, road sensor data 206, map data 208, and/or synthetic data 210. In other examples, the data sources 202 can include more or less sources than shown in FIG. 2 and/or one or more data sources that are not shown in FIG. 2.

Crash databases 204 can include crash data (e.g., data describing crashes and/or associated details) generated by vehicles involved in crashes. The road sensor data 206 can include data collected by one or more sensors (e.g., one or more camera sensors, LIDAR sensors, RADAR sensors, SONAR sensors, IMU sensors, GPS/GNSS receivers, and/or any other sensors) of one or more vehicles while the one or more vehicles drive/navigate one or more real-world environments. The map data 208 can include one or more maps (and, in some cases, associated data) such as, for example and without limitation, one or more high-definition (HD) maps, sensor maps, scene maps, and/or any other maps. In some examples, the one or more HD maps can include roadway information such as, for example, lane widths, location of road signs and traffic lights, directions of travel for each lane, road junction information, speed limit information, etc.

Synthetic data 210 can include virtual assets, objects, and/or elements created for a simulated scene, a virtual scene and/or virtual scene elements, and/or any other synthetic data elements. For example, in some cases, the synthetic data 210 can include one or more virtual vehicles, virtual pedestrians, virtual roads, virtual objects, virtual environments/scenes, virtual signs, virtual backgrounds, virtual buildings, virtual trees, virtual motorcycles/bicycles, virtual obstacles, virtual environmental elements (e.g., weather, lightening, shadows, etc.), virtual surfaces, etc.

In some examples, data from some or all of data sources 202 can be used to create content 212. Content 212 can include static content and/or dynamic content. For example, the content 212 can include roadway information 214, maneuvers 216, scenarios 218, signage 220, traffic 222, co-simulation 224, and/or data replay 226. The roadway information 214 can include, for example, lane information (e.g., number of lanes, lane widths, directions of travel for each lane, etc.), the location and information of road signs and/or traffic lights, road junction information, speed limit information, road attributes (e.g., surfaces, angles of inclination, curvatures, obstacles, etc.), road topologies, and/or other roadway information. The maneuvers 216 can include any AV maneuvers, and the scenarios 218 can include specific AV behaviors in certain AV scenes/environments. Signage 220 can include signs such as, for example, traffic lights, road signs, billboards, displayed messages on the road, etc. The traffic 222 can include any traffic information such as, for example, traffic density, traffic fluctuations, traffic patterns, traffic activity, delays, positions of traffic, velocities, volumes of vehicles in traffic, geometries or footprints of vehicles, pedestrians, spaces (occupied and/or unoccupied), etc.

The co-simulation 224 can include a distributed modeling and simulation of different AV subsystems that form the larger AV system. In some cases, the co-simulation 224 can include information for connecting separate simulations together with interactive communications. In some cases, the co-simulation 224 can allow for modeling to be done at a subsystem level while providing interfaces to connect the subsystems to the rest of the system (e.g., the autonomous driving system computer). Moreover, the data replay 226 can include replay content produced from real-world sensor data (e.g., road sensor data 206).

Environmental conditions 228 can include any information about environmental conditions 228. For example, the environmental conditions 228 can include atmospheric conditions, road/terrain conditions (e.g., surface slope or gradient, surface geometry, surface coefficient of friction, road obstacles, etc.), illumination, weather, road and/or scene conditions resulting from one or more environmental conditions, etc.

Content 212 and the environmental conditions 228 can be used to create the parameterization 230. The parameterization 230 can include parameter ranges, parameterized scenarios, probability density functions of one or more parameters, sampled parameter values, parameter spaces to be tested, evaluation windows for evaluating a behavior of an AV in a simulation, scene parameters, content parameters, environmental parameters, etc. The parameterization 230 can be used by a simulator 232 to generate a simulation 240.

Simulator 232 can include a software engine(s), algorithm(s), neural network model(s), and/or software component(s) used to generate simulations, such as simulation 240. In some examples, the simulator 232 can include ADSC/subsystem models 234, sensor models 236, and a vehicle dynamics model 238. The ADSC/subsystem models 234 can include models, descriptors, and/or interfaces for the autonomous driving system computer (ADSC) and/or ADSC subsystems such as, for example, a perception stack (e.g., perception stack 112), a localization stack (e.g., localization stack 114), a prediction stack (e.g., prediction stack 116), a planning stack (e.g., planning stack 118), a communications stack (e.g., communications stack 120), a control stack (e.g., control stack 122), a sensor system(s), and/or any other subsystems.

Sensor models 236 can include mathematical representations of hardware sensors and an operation (e.g., sensor data processing) of one or more sensors (e.g., a LIDAR, a RADAR, a SONAR, a camera sensor, an IMU, and/or any other sensor). The vehicle dynamics model 238 can model vehicle behaviors/operations, vehicle attributes, vehicle trajectories, vehicle positions, etc.

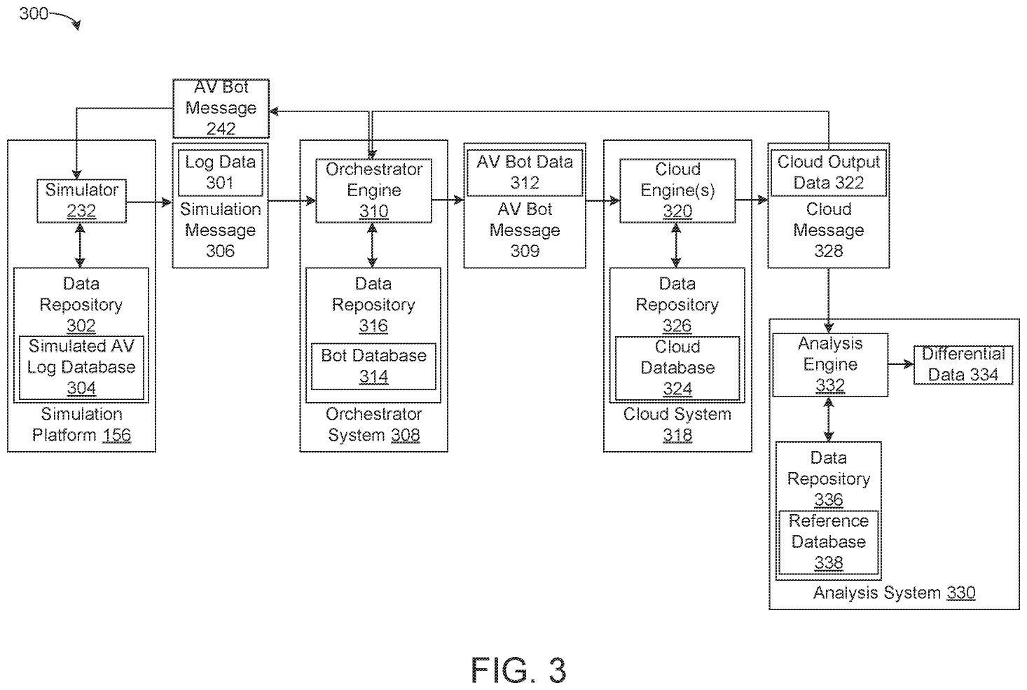

In some examples, simulator 232 of simulation platform 156 may execute a simulation based on a set of cloud messages generated by one or more cloud services. For example, simulator 232 may execute or generate a simulation of a simulated AV responding to the set of cloud messages. In such examples, the set of cloud messages may be in response to a request for assistance and/or information an AV simulated by simulator 232 generates and transmits during a corresponding simulation. For instance, simulator 232 may obtain AV bot message 242 that includes one or more portions of the set of cloud messages from a computing system, such as orchestrator system 308 of FIG. 3.

Referring to FIG. 3, computing environment 300 may include simulation platform 156, orchestrator system 308, cloud system 318, and analysis system 330. As described herein, simulation platform 156 may perform any of the example processes described herein to, among other things, execute a simulation including a simulated AV and generate log data 301 associated with the simulated AV. Log data 301 may include a set of parameters that identify and characterize signals, messages or information that may have been generated by one or more simulated components, systems, modules and/or software stacks of the simulated AV during the simulation. . . . Additionally, the signals, messages or information generated by the one or more simulated components, systems, modules and/or software stacks of the simulated AV during the simulation may be representative of one or more state changes or events of the corresponding simulated components, systems, modules and/or software stacks of the simulated AV during the simulation. Moreover, orchestrator system 308, cloud system 318 and analysis system 330 may utilize log data 301 to test and measure the behavior and/or logic of one or more cloud services.

In some examples, as illustrated in FIG. 3, simulation platform 156, orchestrator system 308, cloud system 318 and analysis system 330 may be included in a single computing system, such as data center computing system 150. In other examples, the functionalities of simulation platform 156, orchestrator system 308, cloud system 318 and analysis system 330 as described herein may be performed by a single, discrete computing system, such as data center computing system 150. In various examples, data center computing system 150 may correspond to a distributed system that includes simulation platform 156, orchestrator system 308, cloud system 318 and analysis system 330. In such examples, simulation platform 156, orchestrator system 308, cloud system 318 and analysis system 330 may each represent a computing system that includes one or more servers and tangible, non-transitory memory devices storing executable code and application modules. The one or more servers may each include one or more processors or processor-based computing devices, which may be configured to execute portions of the stored code or application modules to perform operations consistent with the disclosed embodiments. Additionally, each of simulation platform 156, orchestrator system 308, cloud system 318 and analysis system 330 may be interconnected through any appropriate combination of communications networks. Further, each of simulation platform 156, orchestrator system 308, cloud system 318 and analysis system 330 may include a communications unit or interface coupled to the one or more processors for accommodating wired or wireless communication across one or more communications networks.

Examples of such communications networks includes but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. In some instances, the simulation platform 156, orchestrator system 308, cloud system 318 and analysis system 330 may perform operations that establish and maintain one or more secure channels of communication across the one or more communications network, such as, but not limited to, a transport layer security (TSL) channel, a secure socket layer (SSL) channel, or any other suitable secure communication channel.

As illustrated in FIG. 3, simulator 232 of simulation platform 156 may perform any of the example processes described herein to, among other things, execute a simulation including a simulated AV and generate log data 301 associated with the simulated AV. As described herein, simulation platform 156 and simulator 232 are further described in FIG. 2. Additionally, simulator 232 may generate simulation message 306 and package, within one or more portions of simulation message 306, one or more portions of log data 301. Further, simulator 232 may transmit simulation message 306, including one or more portions of log data 301, to orchestrator system 308. In some instances, simulator 232 may perform operations that store, within the one or more tangible non-transitory memories associated with simulation platform 256, such as simulated AV log database 304 of data repository 302, log data 301.

Orchestrator system 308 may receive simulation message 306 and generate autonomous vehicle (AV) bot scripts associated with the one or more portions of log data 301 included in simulation message 306. In some examples, at least one processor of orchestrator system 308 may execute orchestrator engine 310. Executed orchestrator engine 310 may obtain and parse simulation message 306 to obtain the one or more portions of log data 301. Additionally, executed orchestrator engine 310 may perform any of the exemplary processes described herein to, among other things, generate an AV bot script based on the one or more portions of log data 301. As described herein, the AV bot script may include a sequence of instructions, that when instantiated or executed, generates a set of AV messages that the simulated AV of log data 301 generated during its simulation. Additionally, the sequence of instructions may represent, identify and characterize data state changes, pathways, signals, messages or information that may have been generated by one or more simulated components, systems, modules and/or software stacks of the simulated AV during the simulation. In some instances, the sequence of instructions may be a replay of the state changes, pathways, signals, messages, or information that may have been generated by one or more simulated components, systems, modules and/or software stacks of the simulated AV during the simulation. Moreover, the sequence of instructions may correspond to one or more state changes or events of the simulated components, systems, modules and/or software stacks of the simulated AV during the simulation. In some instances, the AV bot script may include data that identifies one or more cloud services that the simulated AV may be communicating with.

In some examples, orchestrator system 308 may receive a set of cloud messages generated by one or more cloud services, such as cloud services executed by cloud system 318, and may generate one or more AV messages based on one or more portions of the set of cloud messages. Additionally, orchestrator system 308 may provide the one or more AV messages and/or the one or more portions of the set of cloud messages to simulator 232. As described herein, simulator 232 may execute a simulation based on the set of cloud messages. Additionally, the set of cloud messages may be in response to a request for assistance and/or information an AV simulated by simulator 232 generates and transmits during a corresponding simulation. In some instances, such simulations executed by simulator 232 and the generation and transmission of corresponding cloud messages to simulator 232 via orchestrator system 318 may be done together and in real-time. For instance, log data 301 of a simulation may characterize a request for assistance and/or information from a particular cloud service. Additionally, and as described herein, orchestrator system 308 and cloud system 318 may perform any of the example processes described herein to generate a set of cloud messages corresponding to the request for assistance and/or information from the particular cloud service characterized by log data 301. Moreover, cloud system 318 may provide the set of cloud messages to orchestrator system 308 and orchestrator system 308 may generate one or more AV messages based on one or more portions of the set of cloud messages. Further, orchestrator system 308 may provide the one or more AV messages and/or corresponding set of cloud messages to simulator 233.

Additionally, executed orchestrator engine 310, may perform any of the example processes described herein to, among other things, instantiate an AV bot based on the AV bot script or execute the AV bot script. The executed AV bot script or instantiated AV bot may generate a set of AV messages that the simulated AV of log data 301 generated during its simulation. Based on the set of AV messages, executed orchestrator engine 310 may generate AV bot data 312 including the set of AV messages generated by the executed AV bot script or instantiated AV bot. Moreover, executed orchestrator engine 310 may generate AV bot message 309 and package, within one or more portions of AV bot message 309, one or more portions of AV bot data 312. The instantiated AV bot or executed AV bot scripts may provide a layer, within computing environment 300, that enables log data 301 to be communicated to cloud system 318. In some instances, executed orchestrator engine 310 may include, within one or more portions of AV bot message 309, data identifying one or more cloud services that the corresponding simulated AV may be communicating with. The data identifying the one or more cloud services may be obtained from the corresponding AV bot script. Further, executed orchestrator engine 310 may transmit AV bot message 309, including one or more portions of AV bot data 312, to cloud system 318. In some instances, executed orchestrator engine 310 may perform operations that store, within the one or more tangible non-transitory memories of orchestrator system 308, such as simulated bot database 314 of data repository 316, AV bot data 312.

In some examples, executed orchestrator engine 310 may generate multiple AV bot scripts for log data 301. In such examples, the sequence of instructions of each of the multiple AV bot scripts may be different and may represent a variation of the simulation that log data 301 represents. Additionally, executed orchestrator engine 310 may vary one or more aspects of the sequence of instructions for each of the multiple AV bot scripts. That way, the sequence of instructions of each of the multiple AV bot scripts may each represent, identify, and characterize a different set of signals, messages or information that may have been generated by one or more one or more simulated components, systems, modules and/or software stacks of the simulated AV. As described herein, a corresponding set of AV messages of each of the multiple AV bot scripts may be utilized to test and measure the behavior and logic of one or more cloud services. For instance, each set of AV messages may be packaged into a corresponding AV bot message and each AV bot message may be transmitted to cloud system 318. Additionally, each AV bot message may include data identifying one or more cloud services that the corresponding simulated AV may be communicating with. For each set of AV messages, cloud system 318 may test and measure the behaviors or logic of the one or more corresponding cloud services based on the corresponding set of AV messages.

By way of example, executed orchestrator engine 310 may generate a first AV bot script based on the one or more portions of log data 301. Additionally, executed orchestrator engine 310 may generate a second AV bot script that is a variation of the first AV bot script. The second AV bot script may include a sequence of instructions that may be like the first AV bot script but has one or more aspects of the sequence of instructions that is different to the sequence of instructions included in the first AV bot script. In some instances, executed orchestrator engine 310 may adjust one or more aspects of the sequence of instructions of the second AV bot scripts based on one or more user inputs provided by a user operating orchestrator system 308. Additionally, executed orchestrator engine 310 may execute the first AV bot script and the second AV bot script. The executed first AV bot script may generate a first set of AV messages, while the executed second AV bot script may generate a second set of AV messages. Moreover, executed orchestrator engine 310 may perform operations described herein to provide the first set of AV messages and the second set of AV messages to cloud system 318. In some instances, the first AV bot script and the second AV bot script may each be associated with the same cloud service. In such instances, executed orchestrator engine 310 may further provide, to cloud system 318, data identifying a particular cloud service to test and measure the behavior of. Cloud system 318 may test and measure the behavior or logic of a cloud service that cloud system 318 may support and maintain, based on the first set of AV messages and the second set of AV messages.

In other examples, simulator 232 may perform multiple simulations that each include a simulated AV and each simulated AV of each of the multiple simulations is configured differently. In such examples, simulator 232 may generate log data associated with the simulated AV of each of the multiple simulations. In some instances, each of the multiple simulations may be a variation of one another. As described herein, the log data of each of the multiple simulations, such as log data 301, may include a set of parameters that identify and characterize signals, messages or information that may have been generated by one or more simulated components, systems, modules and/or software stacks of the simulated AV during the corresponding simulation. Additionally, simulator 232 may perform operations as described herein to transmit the log data of each of the multiple simulations to executed orchestrator engine 310. Moreover, executed orchestrator engine 310 may perform operations as described herein to generate an AV bot script for each of the log data of each of the multiple simulations. Further, executed orchestrator engine 310 may execute each AV bot script and each executed AV bot script may generate a corresponding set of AV messages. As described herein, executed orchestrator engine 310 may perform operations described herein to provide each set of AV messages of each executed AV bot script to cloud system 318. Cloud system 318 may test and measure the behavior or logic of a cloud service (e.g., a customer support cloud service, telephony communication cloud service or remote assistance cloud service). that cloud system 318 may support and maintain, based on each set of AV messages of each executed AV bot script. For instance, each set of AV messages may be packaged into a corresponding AV bot message and each AV bot message may be transmitted to cloud system 318. Additionally, each AV bot message may include data identifying one or more cloud services that the corresponding simulated AV may be communicating with. For each set of AV messages, cloud system 318 may test and measure the behaviors or logic of the one or more corresponding cloud services based on the corresponding set of AV messages.

In various examples, simulator 232 may perform multiple simulations and executed orchestrator engine 310 may generate multiple AV bot scripts for each of the multiple simulations. In such examples, simulator 232 may generate log data associated with the simulated AV of each of the multiple simulations. In some instances, each of the multiple simulations may be a variation of one another. For instance, each of the multiple simulations may be a variation of a version of a software of the simulated AV. As described herein, the log data of each of the multiple simulations, such as log data 301, may include a set of parameters that identify and characterize signals, messages or information that may have been generated by one or more simulated components, systems, modules and/or software stacks of the simulated AV during the corresponding simulation. Examples of the set of parameters that may be included in log data 301 include, sensor data, kinematic data (e.g., vehicle pose), routing data, in-cabin states and occupancy state, delivery state, planning/behavior states, environmental data (e.g., tracked objects, lane identifiers, etc.). Further, simulator 232 may perform operations as described herein to transmit the log data of each of the multiple simulations to executed orchestrator engine 310.

Additionally, executed orchestrator engine 310 may perform operations as described herein to generate multiple AV bot scripts for each of the log data of each of the multiple simulations. As described herein, the sequence of instructions of each of the multiple AV bot scripts of each of the multiple simulations may be different and may represent a variation of the corresponding log data. In some instances, executed orchestrator engine 310 may, for each log data of each of the multiple simulations, vary one or more aspects of the sequence of instructions for each of the multiple AV bot scripts. That way, the sequence of instructions of each of the multiple AV bot scripts may each represent, identify, and characterize a different set of signals, messages or information that may have been generated by one or more one or more simulated components, systems, modules and/or software stacks of the corresponding simulated AV. As described herein, a corresponding set of AV messages of each of the multiple AV bot scripts may be utilized to test and measure the behavior and logic of one or more cloud services (e.g., a customer support cloud service, telephony communication cloud service or remote assistance cloud service). For instance, each set of AV messages may be packaged into a corresponding AV bot message and each AV bot message may be transmitted to cloud system 318. Additionally, each AV bot message may include data identifying one or more cloud services that the corresponding simulated AV may be communicating with. For each set of AV messages, cloud system 318 may test and measure the behaviors or logic of the one or more corresponding cloud services based on the corresponding set of AV messages.

Referring back to FIG. 3, cloud system 318 may receive AV bot message 309 and generate cloud output data 322 based on the one or more portions of AV bot data 312 included in AV bot message 309. In some examples, at least one processor of cloud system 318 may execute cloud engine 320. Executed cloud engine 320 may obtain AV bot message 309 and parse AV bot message 309 to obtain a set of AV messages included in the one or more portions of AV bot data 312 included in AV bot message 309. In instances where AV bot message 309 includes data that identifies one or more cloud services that the corresponding simulated AV may be communicating with, executed cloud engine 320 may identify and execute a particular cloud service (e.g., a cloud service associated with ride-hail service) to test and measure the behavior of. Alternatively, based on one or more user inputs provided by a user operating cloud system 318, executed cloud engine 320 may identify and execute a particular cloud service to test and measure the behavior of. Additionally, executed cloud engine 320 may provide the set of AV messages to the identified and executed cloud service. The executed cloud service may generate a set of cloud messages. The set of cloud messages may characterize one or more signals, messages or information that the executed cloud service may generate and transmit to the corresponding simulated AV.

Based on the set of cloud messages, executed cloud engine 320 may generate cloud output data 322 that includes the set of cloud messages generated by the identified and executed cloud service. Moreover, executed cloud engine 320 may generate cloud message 328 and package, within one or more portions of cloud message 328, one or more portions of cloud output data 322. Further, executed cloud engine 320 may include, within one or more portions of cloud message 328, data identifying the identified and executed cloud service that generated the set of cloud messages included in the one or more portions of cloud output data 322. In some instances, executed cloud engine 320 may transmit cloud message 328, including the one or more portions of cloud output data 322, to analysis system 330. In other instances, executed cloud engine 320 may perform operations that store, within the one or more tangible non-transitory memories of cloud system 318, such as cloud database 324 of data repository 326, cloud output data 322.

As illustrated in FIG. 3, analysis system 330 may receive cloud message 328 and test and measure the behavior or logic of a cloud service identified in cloud message 328 based on the one or more portions of cloud output data 322 included in cloud message 328. In some examples, at least one processor of analysis system 330 may execute analysis engine 332. Executed analysis engine 332 may obtain cloud message 328 and parse cloud message 328 to obtain the set of cloud messages included in the one or more portions of cloud output data 322 included in cloud message 328. Additionally, executed analysis engine 332 may obtain cloud message 328 and parse cloud message 328 to obtain data identifying the cloud service that generated the set of cloud messages. Further, executed analysis engine 332 may perform any of the example processes described herein to, among other things, test and measure the behavior or logic of the identified cloud service based in part on the set of cloud messages and reference data. As described herein, reference data may identify one or more cloud services and, for each of the one or more cloud services, characterize a set of desired or expected signals, messages or information that the cloud service may generate and transmit to an AV or simulated AV the cloud service may be communicating with. In some instances, the reference data may be based on user provided inputs of what may be expected. In other instances, the reference data may be based on historical data, such as signals, messages or information that may have been generated by one or more components, systems, modules and/or software stacks, generated by one or more AVs (e.g., AV 102 of FIG. 1). In some instances, executed analysis engine 332 may utilize the data identifying the cloud service that generated the set of cloud messages to identify a portion of reference data that references the identified cloud service. In other instances, the reference data may be stored in one or more tangible non-transitory memories of cloud system 318, such as reference database 338 of data repository 326.

By way of example, executed analysis engine 332 may obtain a portion of reference data that is associated with a cloud service identified in cloud message 328. Additionally, executed analysis engine 332 may compare the set of cloud messages to the reference data. Based on the comparison of the cloud output data and the reference data, executed analysis engine 332 may determine whether any differences exist between the set of cloud messages and the reference data.

In some examples, executed analysis engine 332 may determine no differences exist or the set of cloud messages and the reference data match. In such examples, executed analysis engine 332 may determine the identified cloud service is behaving as expected. Additionally, executed analysis engine 332 may generate differential data indicating that the identified cloud service has been verified and is behaving as expected.

In other examples, executed analysis engine 332 may determine one or more differences exist between the set of cloud messages and the reference data. In such examples, executed analysis engine 332 may determine the identified cloud service is not behaving as expected. Additionally, executed analysis engine 332 may generate differential data indicating that the identified cloud service is not behaving as expected. Further, executed analysis engine 332 may determine the one or more differences and include in the differential data characterizing the determined one or more differences. In some instances, additional computing systems may perform operations that determine solutions to mitigate or reduce the occurrence of the unexpected behaviors indicated and characterized in the differential data.

In various examples, simulator platform 156 may execute a simulation based on a set of cloud messages generated by one or more cloud services executed by executed cloud engine 320. In such examples, the set of cloud messages may be in response to a request for assistance and/or information a simulated AV generates and transmits during a corresponding simulation. By way of example, AV bot message 309 may include a set of AV messages that the simulated AV of log data 301 generated during its simulation. Additionally, the set of AV messages may include a request for assistance and/or information from a particular cloud service (e.g., a cloud service associated with remote assistance). Moreover, the cloud service may generate a set of cloud messages based on the set of AV messages of AV bot message 309, as described herein. Executed cloud engine 320 may obtain the set of cloud messages, generate cloud output data 322 that includes the set of cloud messages, and provide cloud output data 322 to orchestrator system 308. In some instances, executed orchestrator engine 310 may generate an AV bot script based on the set of cloud messages and instantiate or execute the AV bot script to generate a set of AV messages (e.g., state changes, pathways, signals, messages, or information that may have been generated by an AV in response to the set of cloud messages). Additionally, executed orchestrator engine 310 may generate AV bot message 242 and include one or more portions of the set of AV messages and/or one or more portions of the set of cloud messages. Moreover, executed orchestrator engine 310 may transmit AV bot message 242 to simulator 232. Simulator 232 of simulation platform 156 may execute a simulation including a simulated AV based on the set of cloud messages and/or the set of AV messages associated with the request for assistance and/or information. In some instances, executed orchestrator engine 310 may generate data, based on the set of cloud messages, that simulator 232 may utilize to execute the simulation.

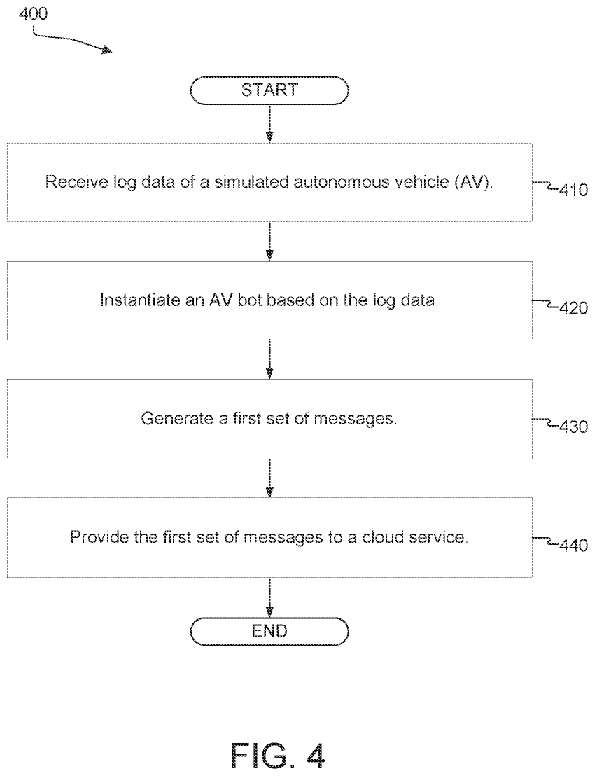

FIG. 4 is a flow chart of an example process 400 for testing and measuring a behavior or logic of one or more cloud services associated with an updated AV bot script. In some instances, one or more components of computing environment 300 may perform all or a portion of the steps of example process 400, which include but are not limited to receiving log data of a simulated autonomous vehicle (AV), instantiating an AV bot based upon the log data, generating a first set of messages, and providing the first set of messages to a cloud service.

Referring to FIG. 4, orchestrator system 308 may receive log data of a simulated autonomous vehicle (AV) (e.g., in step 410). In some examples, orchestrator system 308 may receive log data of the simulated AV from simulation platform 156. In such examples, simulator 232 of simulation platform 156 may transmit simulation message 306, including one or more portions of log data 301, to orchestrator system 308.

As described herein, log data, such as log data 301 may include a set of parameters that identify and characterize signals, messages or information that may have been generated by one or more simulated components, systems, modules and/or software stacks of the simulated AV during the simulation. Additionally, the signals, messages or information generated by the one or more simulated components, systems, modules and/or software stacks of the simulated AV during the simulation may be representative of one or more state changes or events of the corresponding simulated components, systems, modules and/or software stacks of the simulated AV during the simulation.

Referring to FIG. 4, orchestrator system 308 may instantiate an AV bot based on the log data (e.g., in step 420). Additionally, orchestrator system 308 may generating a first set of messages (e.g., in step 430). In some examples, the first set of messages are based on the log data. In other examples, orchestrator system 308 may generate an AV bot script based on the obtained log data. Additionally, orchestrator system 308 may instantiate a bot script or execute the AV bot script. As described herein, the instantiated AV bot or executed bot script may generate the first set of messages, such as a set of AV messages that the simulated AV of the log data may have generated during a corresponding simulation.

By way of example, executed orchestrator engine 310 of orchestrator system 308 may obtain and parse simulation message 306 to obtain the one or more portions of log data 301. Additionally, executed orchestrator engine 310 may perform any of the exemplary processes described herein to, among other things, generate an AV bot script based on the one or more portions of log data 301. As described herein, the AV bot script may include a sequence of instructions, that when instantiated or executed, generates a set of corresponding AV messages. Additionally, the sequence of instructions may represent, identify and characterize data pathways, signals, messages or information that may have been generated by one or more simulated components, systems, modules and/or software stacks of the simulated AV during the simulation. Moreover, the sequence of instructions may correspond to one or more state changes or events of the simulated components, systems, modules and/or software stacks of the simulated AV during the simulation. In some instances, the AV bot script may include data that identifies one or more cloud services that the simulated AV may be communicating with.

In some examples, orchestrator system 308 may instantiate multiple AV bots or execute multiple AV bot scripts for log data of a simulation. In other examples, simulation platform 156 may perform multiple simulations and orchestrator system 308 may instantiate an AV bot or execute an AV bot script for log data of each of the multiple simulations. In various examples, simulation platform 156 may perform multiple simulations and orchestrator system 308 may instantiate multiple AV bots or execute multiple AV bot scripts for log data of each of the multiple simulations.

Referring to FIG. 4, orchestrator system 308, may provide the first set of messages to a cloud service (e.g., in step 440). In some examples, orchestrator system 308 may generate a message and package, within one or more portions of the package, the first set of messages. In some instances, the message may include data identifying one or more cloud services that the simulated AV of the log data may be communicating with. Additionally, orchestrator system 308 may transmit the message to cloud system 318. Cloud system 318 may identify a particular cloud service to execute based on the message. Further, cloud system 318 may provide the first set of messages to the identified cloud service. The identified cloud service may generate a set of cloud messages based on the first set of messages. In some instances, cloud system 318 may provide the set of cloud messages to analysis system 330. Analysis system 330 may test and measure the behavior or logic of the identified cloud service based on the set of cloud messages.

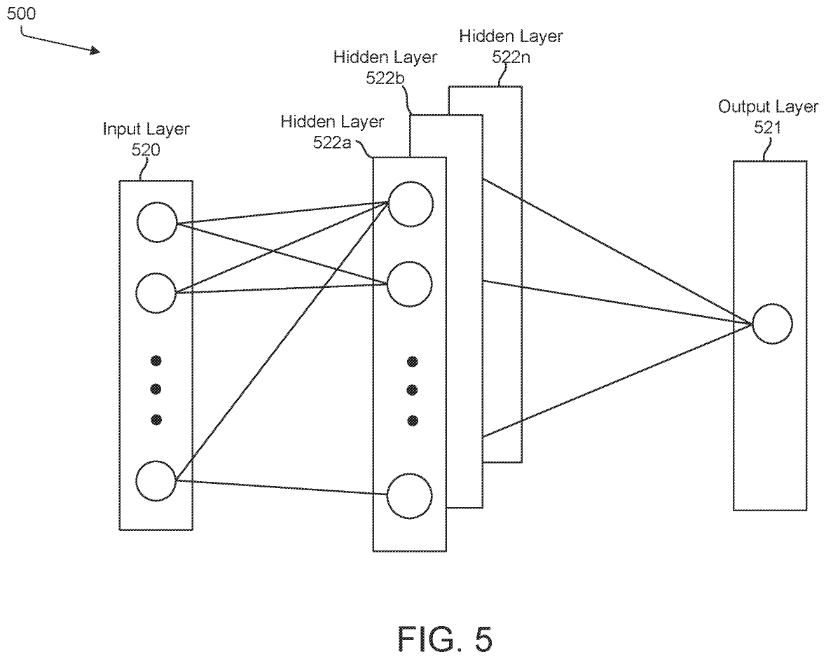

In FIG. 5 the disclosure now turns to a further discussion of models that can be used through the environments and techniques described herein. FIG. 5 is an example of a deep learning neural network 500 that can be used to implement all or a portion of the systems and techniques described herein (e.g., neural network 500 can be used to implement a perception module (or perception system) as discussed above). An input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application.

Neural network 500 further includes an output layer 521 that provides an output resulting from the processing performed by the hidden layers 522a, 522b, through 522n. Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(1/2(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:
Aspect 1: A computing system comprising: a communications unit; a storage unit storing instructions; and at least one processor coupled to the communications unit and the storage unit, the at least one processor being configured to execute the instructions to: receive log data of a simulated autonomous vehicle (AV), the log data characterizing one or more events that occurred during a simulation of the simulated AV; instantiate an AV bot based on the log data; generate, by the instantiated AV bot, a first set of messages wherein the first set of messages are based on the log data; and provide the first set of messages to a cloud service.
Aspect 2: The computing system of Aspect 1, wherein the at least one processor is further configured to: receive cloud output data associated with the cloud service, the cloud output data including data identifying and characterizing a set of cloud messages generated by the cloud service; and implement operations that test and measure a behavior of the cloud service based on the cloud output data.
Aspect 3: The computing system of Aspect 2, wherein the at least one processor is further configured to: receive reference data associated with the cloud service, the reference data including data identifying and characterizing a second set of cloud messages outputted from the cloud service and based on a second set of messages generated by a second AV bot; and wherein, the operations that test and measure the behavior of the cloud service are further based on the cloud output data and the reference data.
Aspect 4: The computing system of Aspect 1 to 3, wherein the one or more events are associated with a change in state of the simulated AV.
Aspect 5: The computing system of Aspect 1 to 4, wherein the one or more events are associated with a software stack version of the simulated AV.
Aspect 6: The computing system of Aspect 1 to 5, wherein the one or more events are associated with a change in one or more processes of the simulated AV.
Aspect 7: The computing system of Aspect 1 to 6, wherein the at least one processor is further configured to: receive cloud output data associated with the cloud service, the cloud output data including data identifying and characterizing a set of cloud messages generated by the cloud service; instantiate a second AV bot based on the cloud output data; generate, by the instantiated second AV bot, a second set of messages, wherein the second set of messages are based on the cloud output data; and provide the second set of messages to a simulator.
Aspect 8: A computer-implemented method comprising: receiving log data of a simulated autonomous vehicle (AV), the log data characterizing one or more events that occurred during a simulation of the simulated AV; instantiating an AV bot based on the log data; generating, by the instantiated AV bot, a first set of messages wherein the first set of messages are based on the log data; and providing the first set of messages to a cloud service.
Aspect 9: The computer-implemented method of Aspect 8, further comprising: receiving cloud output data associated with the cloud service, the cloud output data including data identifying and characterizing a set of cloud messages generated by the cloud service; and implementing operations that test and measure a behavior of the cloud service based on the cloud output data.
Aspect 10: The computer-implemented method of Aspect 9, further comprising: receiving reference data associated with the cloud service, the reference data including data identifying and characterizing a second set of cloud messages outputted from the cloud service and based on a second set of messages generated by a second AV bot; and wherein, the operations that test and measure the behavior of the cloud service are further based on the cloud output data and the reference data.
Aspect 11: The computer-implemented method of Aspect 8 to 10, wherein the one or more events are associated with a change in state of the simulated AV.
Aspect 12: The computer-implemented method of Aspect 8 to 11, wherein the one or more events are associated with a software stack version of the simulated AV.
Aspect 13: The computer-implemented method of Aspect 8 to 12, wherein the one or more events are associated with a change in one or more processes of the simulated AV.
Aspect 14: The computer-implemented method of Aspect 8 to 13, further comprising: receiving cloud output data associated with the cloud service, the cloud output data including data identifying and characterizing a set of cloud messages generated by the cloud service; instantiating a second AV bot based on the cloud output data; generating, by the instantiated second AV bot, a second set of messages, wherein the second set of messages are based on the cloud output data; and providing the second set of messages to a simulator.
Aspect 15: A tangible, non-transitory computer readable medium storing instructions that, when executed by at least one processor, cause the at least one processor to perform operations comprising: receiving log data of a simulated autonomous vehicle (AV), the log data characterizing one or more events that occurred during a simulation of the simulated AV; instantiating an AV bot based on the log data; generating, by the instantiated AV bot, a first set of messages wherein the first set of messages are based on the log data; and providing the first set of messages to a cloud service.
Aspect 16: The tangible, non-transitory computer readable medium of Aspect 15, and wherein the at least one processor further performs operations comprising: receiving cloud output data associated with the cloud service, the cloud output data including data identifying and characterizing a set of cloud messages generated by the cloud service; and implementing operations that test and measure a behavior of the cloud service based on the cloud output data.
Aspect 17: The tangible, non-transitory computer readable medium of Aspect 16, and wherein the at least one processor further performs operations comprising: receiving reference data associated with the cloud service, the reference data including data identifying and characterizing a second set of cloud messages outputted from the cloud service and based on a second set of messages generated by a second AV bot; and wherein, the operations that test and measure the behavior of the cloud service are further based on the cloud output data and the reference data.
Aspect 18: The tangible, non-transitory computer readable medium of Aspect 15 to 17, wherein the one or more events are associated with a change in state of the simulated AV.
Aspect 19: The tangible, non-transitory computer readable medium of Aspect 15 to 18, wherein the one or more events are associated with a software stack version of the simulated AV.
Aspect 20: The tangible, non-transitory computer readable medium of Aspect 15 to 19, wherein the one or more events are associated with a change in one or more processes of the simulated AV.
Aspect 21: The tangible, non-transitory computer readable medium of Aspect 15 to 20, wherein the simulated AV data is based on a first configuration of the simulated AV. The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computing system comprising:
a communications unit;
a storage unit storing instructions; and
at least one processor coupled to the communications unit and the storage unit, the at least one processor being configured to execute the instructions to:
receive log data of a simulated autonomous vehicle (AV), the log data characterizing one or more events that occurred during a simulation of the simulated AV;
instantiate an AV bot based on the log data;
generate, by the instantiated AV bot, a first set of messages wherein the first set of messages are based on the log data; and
provide the first set of messages to a cloud service.

2. The computing system of claim 1, wherein the at least one processor is further configured to:
receive cloud output data associated with the cloud service, the cloud output data including data identifying and characterizing a set of cloud messages generated by the cloud service; and
implement operations that test and measure a behavior of the cloud service based on the cloud output data.

3. The computing system of claim 2, wherein the at least one processor is further configured to:
receive reference data associated with the cloud service, the reference data including data identifying and characterizing a second set of cloud messages outputted from the cloud service and based on a second set of messages generated by a second AV bot; and
wherein, the operations that test and measure the behavior of the cloud service are further based on the cloud output data and the reference data.

4. The computing system of claim 1, wherein the one or more events are associated with a change in state of the simulated AV.

5. The computing system of claim 1, wherein the one or more events are associated with a software stack version of the simulated AV.

6. The computing system of claim 1, wherein the one or more events are associated with a change in one or more processes of the simulated AV.

7. The computing system of claim 1, wherein the at least one processor is further configured to:
receive cloud output data associated with the cloud service, the cloud output data including data identifying and characterizing a set of cloud messages generated by the cloud service;
instantiate a second AV bot based on the cloud output data;
generate, by the instantiated second AV bot, a second set of messages, wherein the second set of messages are based on the cloud output data; and
provide the second set of messages to a simulator.

8. A computer-implemented method comprising:
receiving log data of a simulated autonomous vehicle (AV), the log data characterizing one or more events that occurred during a simulation of the simulated AV;
instantiating an AV bot based on the log data;
generating, by the instantiated AV bot, a first set of messages wherein the first set of messages are based on the log data; and
providing the first set of messages to a cloud service.

9. The computer-implemented method of claim 8, further comprising:
receiving cloud output data associated with the cloud service, the cloud output data including data identifying and characterizing a set of cloud messages generated by the cloud service; and
implementing operations that test and measure a behavior of the cloud service based on the cloud output data.

10. The computer-implemented method of claim 9, further comprising:
receiving reference data associated with the cloud service, the reference data including data identifying and characterizing a second set of cloud messages outputted from the cloud service and based on a second set of messages generated by a second AV bot; and
wherein, the operations that test and measure the behavior of the cloud service are further based on the cloud output data and the reference data.

11. The computer-implemented method of claim 8, wherein the one or more events are associated with a change in state of the simulated AV.

12. The computer-implemented method of claim 8, wherein the one or more events are associated with a software stack version of the simulated AV.

13. The computer-implemented method of claim 8, wherein the one or more events are associated with a change in one or more processes of the simulated AV.

14. The computer-implemented method of claim 8, further comprising:
receiving cloud output data associated with the cloud service, the cloud output data including data identifying and characterizing a set of cloud messages generated by the cloud service;
instantiating a second AV bot based on the cloud output data;
generating, by the instantiated second AV bot, a second set of messages, wherein the second set of messages are based on the cloud output data; and
providing the second set of messages to a simulator.

15. A tangible, non-transitory computer readable medium storing instructions that, when executed by at least one processor, cause the at least one processor to perform operations comprising:
receiving log data of a simulated autonomous vehicle (AV), the log data characterizing one or more events that occurred during a simulation of the simulated AV;
instantiating an AV bot based on the log data;
generating, by the instantiated AV bot, a first set of messages wherein the first set of messages are based on the log data; and
providing the first set of messages to a cloud service.

16. The tangible, non-transitory computer readable medium of claim 15, and wherein the at least one processor further performs operations comprising:
receiving cloud output data associated with the cloud service, the cloud output data including data identifying and characterizing a set of cloud messages generated by the cloud service; and
implementing operations that test and measure a behavior of the cloud service based on the cloud output data.

17. The tangible, non-transitory computer readable medium of claim 16, and wherein the at least one processor further performs operations comprising:
receiving reference data associated with the cloud service, the reference data including data identifying and characterizing a second set of cloud messages outputted from the cloud service and based on a second set of messages generated by a second AV bot; and
wherein, the operations that test and measure the behavior of the cloud service are further based on the cloud output data and the reference data.

18. The tangible, non-transitory computer readable medium of claim 15, wherein the one or more events are associated with a change in state of the simulated AV.

19. The tangible, non-transitory computer readable medium of claim 15, wherein the one or more events are associated with a software stack version of the simulated AV.

20. The tangible, non-transitory computer readable medium of claim 15, wherein the one or more events are associated with a change in one or more processes of the simulated AV.
